(19) United States
(12) Patent Application Publication
(10) Pub. No.: US 2026/0368332 A1
(43) Pub. Date: Nov. 19, 2026

(54) GENERATION OF SEMANTICALLY SIMILAR TEXT SETS FOR LOCATING VULNERABILITY AND WEAKNESS IN A TARGET GENERATIVE AI SYSTEM

(71) Applicant: INTERNATIONAL BUSINESS MACHINES CORPORATION, ARMONK, NY (US)

(72) Inventors: Mikael Hillborg, Umea (SE); Gabriela Rodriguez-Florido, San Jose, CA (US); Alex Wilson, Ernakulam (IN); Aurangazeeb A K, Kerala (IN)

(21) Appl. No.: 19/211,100

(22) Filed: May 16, 2025

(51) Int. Cl. G06F 21/57

(52) U.S. Cl. CPC G06F 21/577; G06F 2221/033

(57) ABSTRACT

A set of challenge texts for locating vulnerabilities and weaknesses in a target Generative AI system is generated. A plurality of rewritten texts are generated from an original text, where generating each rewritten text includes using an AI text generator configured for natural language processing and generation to apply a statistically unique sequence of operations to the original text. Semantic similarity of each rewritten text to the original text is determined; and each rewritten text that has been determined to be semantically similar to the original text is added to the set of challenge texts.

### BACKGROUND

### Technical Field

The present disclosure generally relates to text analysis, and more particularly, to testing of a text-based Generative artificial intelligence (AI) system.

### Description of the Related Art

Generative AI refers to artificial intelligence that creates new, original content such as text, images, and other media. Generative AI applications may be based on advanced machine learning models such as large language models, generative adversarial networks, and transformers.

A chatbot is an example of a Generative AI application that generates text. A chatbot can maintain a conversation with a user in natural language while simulating the way a human would behave. Many businesses use chatbots to answer simple questions and increase customer engagement.

### SUMMARY

According to various embodiments, a computer-implemented method, a computer system, and a computer program product are provided for generating a set of challenge texts for locating vulnerabilities and weaknesses in a target Generative AI system. A plurality of rewritten texts are generated from an original text, where generating each rewritten text includes using an AI text generator configured for natural language processing and generation to apply a statistically unique sequence of operations to the original text. Semantic similarity of each rewritten text to the original text is determined; and each rewritten text that has been determined to be semantically similar to the original text is added to the set of challenge texts.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 is a particularly configured computing environment, consistent with an illustrative embodiment.

FIG. 2 is a method of generating challenge texts for a target Generative AI system, consistent with an illustrative embodiment.

FIG. 3 is a method of generating a statistically unique sequence of operations, consistent with an illustrative embodiment.

FIG. 4 is an illustration of logical components of a challenge-generation system, consistent with an illustrative embodiment.

FIG. 5 is a method of using a set of challenge texts to identify vulnerabilities and weaknesses of a target Generative AI system, consistent with an illustrative embodiment.

### DETAILED DESCRIPTION

### Overview and Support

In the following detailed description, numerous specific details are set forth by way of examples in order to provide a thorough understanding of the relevant teachings. However, it should be apparent that the present teachings may be practiced without such details. In other instances, well-known methods, procedures, components, and/or circuitry have been described at a relatively high-level, without detail, in order to avoid unnecessarily obscuring aspects of the present teachings.

According to an embodiment of the present disclosure, a computer-implemented method, a computer system, and a computer program product are provided for generating a set of challenge texts for locating vulnerabilities and weaknesses in a target Generative AI system. A plurality of rewritten texts are generated from an original text, where generating each rewritten text includes using an AI text generator configured for natural language processing and generation to apply a statistically unique sequence of operations to the original text. Semantic similarity of each rewritten text to the original text is determined; and each rewritten text that has been determined to be semantically similar to the original text is added to the set of challenge texts.

The method offers a fast and computationally efficient way to generate a set of challenge texts that can probe a Generative AI system for vulnerabilities and weaknesses. In particular, statistically unique sequences are used to generate rewritten texts that are syntactically different.

In some embodiments, which can be combined with the previous embodiment, a distance function is used to determine the semantic similarity of each rewritten text. The distance function offers a fast and computationally efficient way to determine semantic similarity.

In some embodiments, which can be combined with one or more of the previous embodiments, the operations are applied in randomly-generated amounts aiming to make each sequence unique from a statistical point of view. Randomly-generated amounts provide a fast and computationally efficient approach towards achieving this aim.

In some embodiments, which can be combined with one or more of the previous embodiments, the randomly-generated amounts are normalized for each sequence, and the normalized amounts are scaled with a complexity level.

In some embodiments, which can be combined with one or more of the previous embodiments, at least some of the plurality of rewritten texts are generated by applying sequences with different complexity levels.

In some embodiments, which can be combined with one or more of the previous embodiments, one or more entities are used to focus on rewriting features of the original text.

In some embodiments, which can be combined with one or more of the previous embodiments, generating an application-specific operation includes gathering descriptive information about the original text; creating a description including a request to suggest modifications to the original text in view of the description; and sending the description to the AI text generator.

In some embodiments, which can be combined with one or more of the previous embodiments, the set of challenges are sent to the target Generative AI system to identify vulnerabilities and weaknesses in the target Generative AI system. The challenge texts offer a computationally efficient way to identify vulnerabilities and weaknesses in the target Generative AI system.

### Example Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

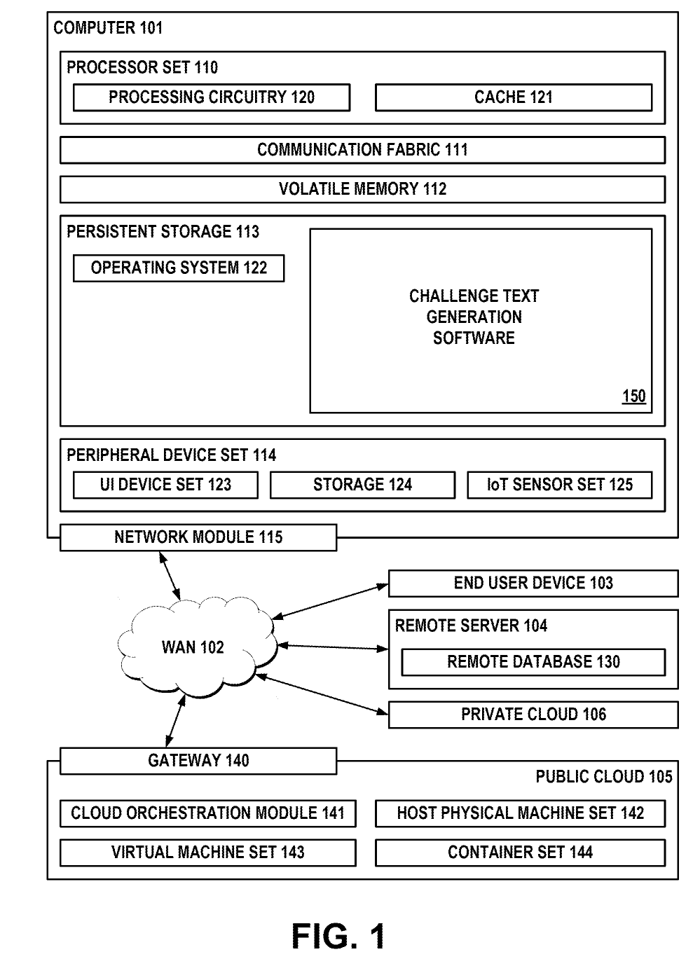

Reference is made to FIG. 1. A computing environment 100 includes an example of an environment for the execution of at least some of the computer code involved in performing the inventive methods, such as challenge text generation software 150. The computing environment 100 includes, for example, computer 101. The computing environment 100 may also include other features, such as a wide area network (WAN) 102, end user device 103, remote server 104, public cloud 105, and private cloud 106. In this embodiment, the computer 101 includes processor set 110, communication fabric 111, volatile memory 112, persistent storage 113 (including operating system 122 and the challenge text generation software 150), peripheral device set 114 (including user interface (UI) device set 123, storage 124, Internet of Things (IoT) sensor set 125), and network module 115.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

At least some of the instructions for performing the inventive methods may be stored in persistent storage 113 as part of challenge text generation software 150. The instructions, when executed, cause the processor set 110 to perform the inventive methods, including generating a set of challenge texts for locating vulnerabilities and weaknesses in a target Generative AI system. The challenge text generation software 150 may be standalone or it may be integrated with a larger operation.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through a network. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. In some embodiments, remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example Method for Generating a Set of Challenge Texts

As used herein, the term semantic and variations thereof (e.g., semantically) refer to the relationship between words and their meanings.

As used herein, the term syntax and variations thereof (e.g., syntactic, syntactically) refer to rules governing the structure of sentences. Central concerns of syntax include word order, grammatical relations, constituency, agreement, and the relationship between form an meaning.

The example method utilizes an AI text generator having an architecture, now known or to be developed in the future, that is configured for natural language processing and generation. On example of a deep learning architecture that is now known is a Transformer. A large language model (LLM) may have a Transformer.

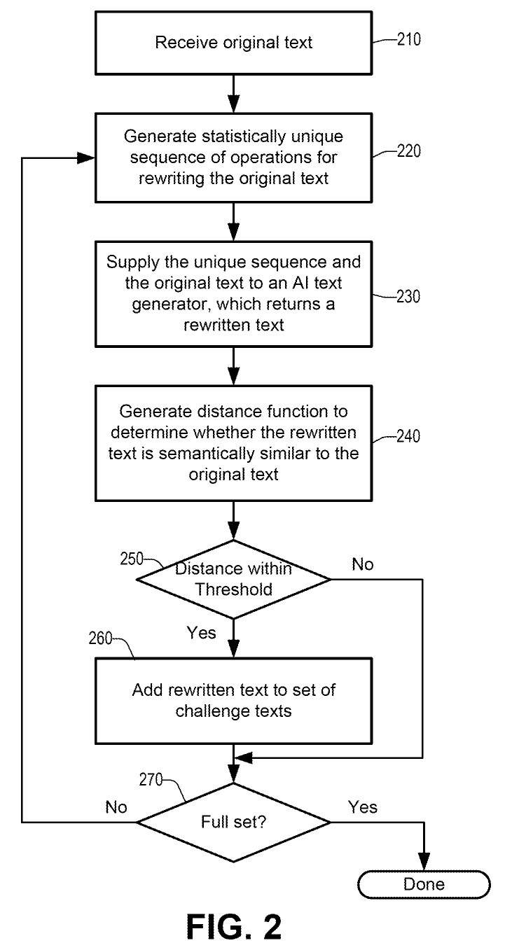

Reference is now made to FIG. 2, which shows an example computer-implemented method for generating a set of challenge texts that can be used to locate vulnerabilities and weaknesses in a target Generative AI system. For example, the target Generative AI system may run a Chatbot or other application that is designed to have textual or spoken conversations. Another example is a target Generative AI system that analyzes free-text survey responses by classifying the comments a user might have. If two comments have the same meaning (semantics) but are formulated in different ways, then the result (classification) should be the same.

At block 210, an original text is received. In some instances, the original text may be intended for processing by the target Generative AI system. If the target Generative AI system is an LLM, the text may be included in a prompt. The prompt may also have a few sections that provide instructions to the LLM.

At block 220, a statistically unique sequence of operations for rewriting the original text is generated. Each operation in the sequence will instruct the AI text generator to modify the original text in a certain manner. The following are a few examples of operations. An operation rewrites the original text into a more relaxed and informal style. An operation rewrites the original text in a more strict or formal style. An operation rewrites the original text to simulate someone who is not fluent or familiar in the language by introducing spelling errors and incorrect punctuation. An operation rewrites the original text to reflect a particular emotion (e.g., anger). An operation rewrites the original text into verbose style or a very vague style.

At block 230, the statistically unique sequence and the original text are supplied to the AI text generator. The AI text generator applies the statistically unique sequence of operations to the original text and produces a rewritten text.

At blocks 240 and 250, a determination is made as to whether the rewritten text is semantically similar to the original text. The semantic similarity may be determined by a distance function. The distance function checks if the rewritten text is within a threshold of the original text. The distance function can be a function that compares vector embeddings within a user defined threshold or a simple text comparison function, such as “equal” or “contains.” Multiple distance functions are available, including numeric (scalar, Euclidian etc.) functions.

At block 260, the rewritten text is added to the set of challenge texts if the rewritten text has been determined to be semantically similar to the original text (for example, the distance is within the threshold). If there is no semantic similarity, the rewritten text is not added.

If it is desired to add another rewritten text to the set of challenge texts (block 270), control is returned to block 220. Once a full set of challenge texts has been obtained (for example, the number of rewritten texts in the set reaches a user-defined set size), the method is finished.

In the set of challenge texts, each rewritten text is generated from a statistically unique sequence of operations. No two rewritten texts are generated from the same sequence. While possible, it is highly unlikely that two rewritten texts in the set are syntactically identical. No rewritten text in the set is syntactically identical to the original text. All of the rewritten texts in the set are semantically similar to the original text.

The method of FIG. 2 offers a fast and computationally efficient way to generate a set of challenge texts that can probe a Generative AI system for vulnerabilities and weaknesses. In particular, statistically unique sequences are used to generate rewritten texts that are syntactically different, and the distance function is a quick and efficient way to ensure semantic similarity.

### Example Method for Generating a Statistically Unique Sequence of Operations

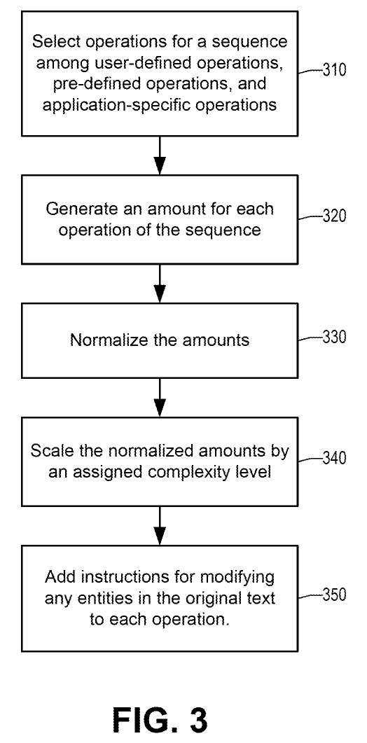

Reference is now made to FIG. 3. Prior to performing the method of FIG. 3, settings have already been defined, and entities and an original text have already been received. The settings may include an initial complexity level, choice of distance function, distance threshold, disallowed operations, and set size.

As used herein, an entity refers to a word or a phrase that is important and should be given special attention. In some instances, the original text may be rewritten without changing any entities. In other instances, the original text may be rewritten to have an impact on the entities only.

At block 310, operations for the sequence are selected. Different types of operations include user-defined operations that are supplied at runtime by a user; pre-defined operations that are accessed from storage; and application-specific operations that are generated by an AI text generator. Certain types of operations may be disallowed per the settings. For example, the following three operations are selected and ordered: (1) formal style, (2) angry, (3) misspellings.

In some instances, the operations may be provided in a specific order, and the order is recorded. In other instances, the operations are not provided in any specific order.

An application-specific operation may be generated as follows. Information about the original text is gathered, for example, by examining metadata that represents an application of the original text. A request to suggest different ways of modifying a text in view of the information is generated

The request may include the following example of a description:

Given is a description of a text, between the DESC tags. List three ways to modify the text in terms of the domain, adding domain keywords and verbose text that is relevant for the domain, but without changing the meaning of the text. For example, a text which is a question about a car engine could be modified to include words about which type of engine it is. Or a text about surgery could include words about tools and procedures related to surgery.

The request is sent to an AI text generator. The AI text generator returns one or more suggested operations. Any or all of the suggested operations may be added to the sequence.

At block 320, an amount is generated for each operation of the sequence. The amount influences the magnitude of the applied operation. A misspellings operation having a high amount will create more misspelled words in the rewritten text than a misspellings operation having a lower amount. An operation having a high amount of anger will be produce angrier expressions in the rewritten text than an operation having a lower amount of anger. The amount for each operation may be randomly generated.

At block 330, the amounts for the sequence are normalized. For example, the highest amount is scaled by a factor to equal 1, and the other amounts are scaled by the same factor. Consider an example in which the amounts prior to normalization are 0.5 for a first operation, 0.3 for a second operation, 0.2 for a third operation. After normalization, the amounts would be 1.0, 0.6 and 0.4.

At block 340, the normalized amounts are scaled by an assigned complexity level. That is, the complexity level is used as a scale factor for each operation. The complexity level may specify (1) number of words or characters that can be changed and (2) number of operations that can be applied to the text (the latter is how many times it can be rewritten to obtain multiple properties). The higher the complexity level, the more of the text (in terms of words or characters) is modified. Thus, if the amounts after normalization, are 1.0, 0.6 and 0.4, and if the complexity level is 0.5, the amounts after scaling are 0.5, 0.3 and 0.2. Instructions for performing the operations in the scaled, normalized amounts are added to the sequence.

At block 350, instructions for modifying any entities in the original text are added to the sequence. The AI text generator might then be instructed to not rewrite the entities but will have the freedom to rewrite everything else, or the AI text generator might then be instructed to rewrite the entities but not change any other portions of the text.

Setting random amounts for the operations is a computationally efficient way to aim to make each sequence and each rewritten text unique from a statistical point of view. In the context herein, “statistically unique” and “from a statistical point of view” refer to a high likelihood that the rewritten texts will be unique, but without a guarantee that two rewritten texts won't be identical. Thus, the method takes a "Monte Carlo" approach towards the rewritten texts by using randomness to generate a distribution of rewritten texts such that the likelihood of two rewritten texts being identical is very small but not zero.

Batches of sequences may be produced by repeating the method of FIG. 3. The sequences of each batch are produced with the same complexity level, but different batches are assigned different complexity levels. For example, a first batch of sequences is produced with the initial complexity level, a second batch of sequences is produced with a different complexity level, and so on.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail herein, the operational/functional language is to be read in its proper technological context, i.e., as concrete specifications for physical implementations.

It should be appreciated that the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably processed manually by a human user.

### Example Logical Components of a System for Generating a Set of Challenge Texts

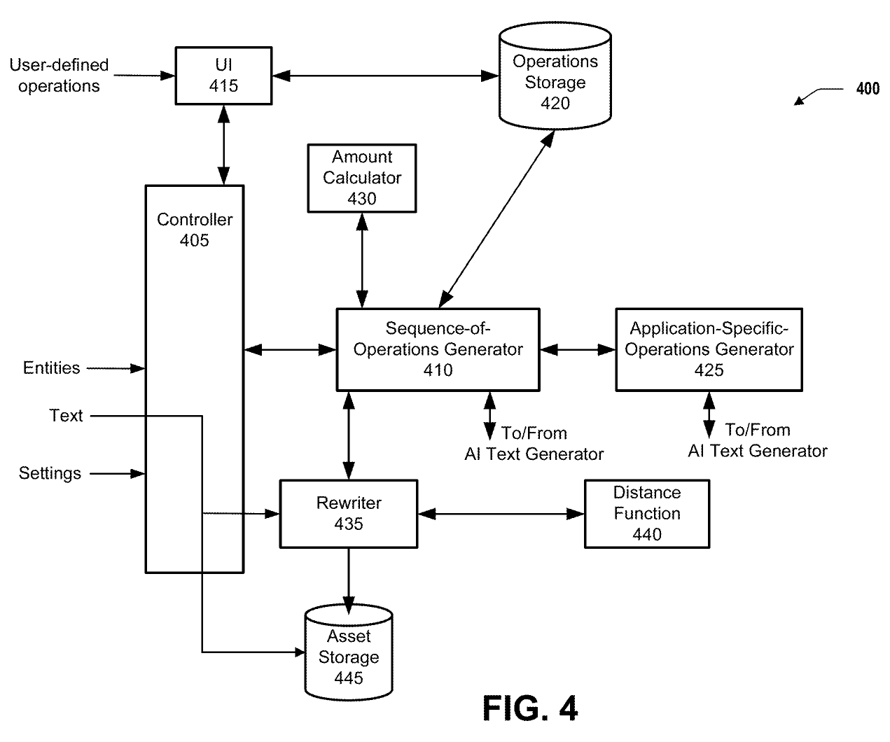

Reference is now made to FIG. 4, which shows logical components of a system 400 for generating a set of challenge texts for locating vulnerabilities and weaknesses in a target Generative AI system. The system 400 includes a controller 405 that is configured to receive an original text, settings, and an optional set of entities. The settings include a level of complexity. (e.g., a value on a scale of 0 to 100). The settings may identify operations that are allowed and disallowed. Where an entity is received, the settings may also indicate whether (a) only entity in the original text should be modified, (b) whether all text other than the entity should be modified, or (c) possibly but not necessarily the entity should be modified. Other settings may include distance parameters and set size.

The system 400 further includes a sequence-of-operations generator 410, a user interface (UI) 415 (e.g., a plug-in), and operations storage 420. The controller 405 calls the sequence-of-operations generator 410, which generates a sequence of operations, subject to the allowed/disallowed operations.

The operations in a sequence may be any mix of pre-defined operations, user-defined operations, and application-specific operation. The sequence-of-operations generator 410 may access operations that are pre-defined from the operations storage 420. The sequence-of-operations generator 410 may access operations that are user-defined from the user interface 415. User-defined operations may then be stored in the operations storage 420.

The sequence-of-operations generator 410 may access operations that are application-specific by calling an application-specific-operations generator 425, which generates a set of application-specific modifications to the original text. In some embodiments, the application-specific-operations generator 425 accesses metadata about the original text, creates a description that requests changes involving the metadata, and sends the description to an AI text generator. The AI text generator responds with some suggested operations.

The sequence-of-operations generator 410 calls an amount calculator 430 to calculate an amount for each operation. Each amount is normalized and scaled by the level of complexity.

When a sequence of operations is generated, it is sent to an AI text generator. The AI text generator responds with rewritten text.

A rewriter 435 determines whether the rewritten text is semantically similar to the original text. The rewriter 435 calls a distance function 440, which returns a distance. If the distance indicates that the rewritten text is semantically similar to the original text, the rewritten text is stored in asset storage 445.

The rewritten text may be stored together with references to the original text and the complexity and other settings and the distance returned by the distance function 440. The stored rewritten texts may be reused in multiple sessions. For example, a set A_{orig} of original texts is stored in asset storage 445. A set Aᵥₐᵣ₁ of variations of the set A_{orig} of original texts is generated, used for fine-tuning an AI text generator, and stored in the asset storage 445 for future use. A set Aᵥₐᵣ₂ of variations of the set Aᵥₐᵣ₁ is generated and used for additional fine tuning. The level of complexity that was applied when creating each variation Aᵥₐᵣ₁ and Aᵥₐᵣ₂ may also be stored and used for the fine tuning.

Additional rewritten texts are generated added to the asset storage 445 until the set size (per the settings) is reached or some other termination condition is met.

With additional reference to FIG. 1, the challenge text generation software 150 on computer 101 implements the controller 405, the sequence-of-operations generator 410, the UI 415, the application-specific-operations generator 425, the rewriter 435, and the distance function 440. In some embodiments, the operations storage 420 and the asset storage 445 may be located in persistent storage 113. In other embodiments, the operations storage 420 and the asset storage 445 may be located on any of remote server 104, public cloud 105 and private cloud 106.

In the example of FIG. 4, the AI text generator is not part of the system 400 but rather is maintained (e.g., owned, operated, controlled) by a third party. In some embodiments, however, the AI text generator may be part of the system 400.

### Example Method of Using a Set of Challenge Texts

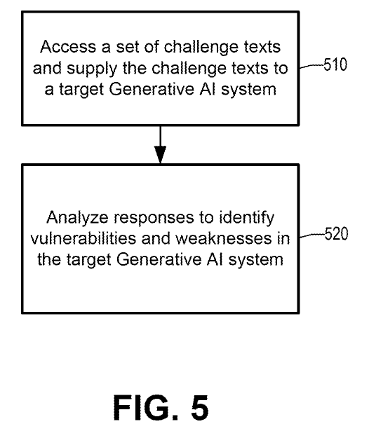

Reference is now made to FIG. 5, which illustrates an example method of using a set of challenge texts. At block 510, a set of challenge texts is accessed, for example from asset storage, and supplied to a target Generative AI system. The target Generative AI system provides responses to the challenge texts.

At block 520, the responses are analyzed to identify vulnerabilities and weaknesses in the target Generative AI system. An algorithm may be used to identify an operation that causes the target AI Generative system to fail. However, one operation alone might not necessarily cause a failure, but it does cause a failure in combination with at least one other operation. A clustering algorithm may be particularly advantageous for sequences involving multiple operations. The clustering algorithm can identify patterns of certain combinations of operations that cause the target Generative AI system to fail.

### Conclusion

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

The components, steps, features, objects, benefits and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for generating a set of challenge texts for locating vulnerabilities and weaknesses in a target Generative AI system, the computer-implemented method comprising:
generating a plurality of rewritten texts from an original text using an AI text generator configured for natural language processing and generation, wherein generating each rewritten text comprises using the AI text generator to apply a statistically unique sequence of operations to the original text;
determining semantic similarity of each rewritten text with the original text; and
adding to the set of challenge texts each rewritten text that has been determined to be semantically similar to the original text.

2. The computer-implemented method of claim 1, wherein a distance function is used to determine the semantic similarity of each rewritten text.

3. The computer-implemented method of claim 1, wherein the operations are applied in randomly-generated amounts aiming to make each sequence unique from a statistical point of view.

4. The computer-implemented method of claim 3, further comprising:
normalizing the randomly-generated amounts for each sequence, and
scaling the normalized amounts with a complexity level.

5. The computer-implemented method of claim 4, wherein at least some of the plurality of rewritten texts are generated by applying sequences with different complexity levels.

6. The computer-implemented method of claim 1, further comprising using one or more entities to focus on rewriting features of the original text.

7. The computer-implemented method of claim 1, wherein the operations comprise:
user-defined operations that are accessed from a user interface;
pre-defined operations that are accessed from storage; and
application-specific operations that are generated in real time.

8. The computer-implemented method of claim 6, wherein generating an application- specific operation comprises:
gathering descriptive information about the original text;
creating a description including a request to suggest modifications to the original text in view of the description; and
sending the description to the AI text generator.

9. The computer-implemented method of claim 1, further comprising sending the set of challenge texts to the target Generative AI system to identify vulnerabilities and weaknesses in the target Generative AI system.

10. A computer system comprising a memory having computer readable instructions; and one or more processors for executing the computer readable instructions to configure the computer system to perform a method for generating a set of challenge texts for locating vulnerabilities and weaknesses in a target Generative AI system, the method comprising:
generating a plurality of rewritten texts from an original text, wherein generating each rewritten text comprises using an AI text generator configured for natural language processing and generation to apply a statistically unique sequence of operations to the original text;
determining semantic similarity of each rewritten text with the original text; and
adding to the set of challenge texts each rewritten text that has been determined to be semantically similar to the original text.

11. The computer system of claim 10, wherein a distance function is used to determine the semantic similarity of each rewritten text.

12. The computer system of claim 10, wherein the operations are applicable in randomly-generated amounts aiming to make each sequence unique from a statistical standpoint.

13. The computer system of claim 12, wherein the method further comprises:
normalizing the randomly-generated amounts for each sequence, and
scaling the normalized amounts with a complexity level.

14. The computer system of claim 10, wherein the operations comprise:
user-defined operations;
pre-defined operations; and
application-specific operations.

15. The computer system of claim 10, wherein the method further comprises sending the set of challenge texts to the target Generative AI system to identify vulnerabilities and weaknesses in the target Generative AI system.

16. A computer program product comprising one or more computer-readable memory devices encoded with data including instructions that, when executed, causes a processor set to carry out a method for generating a set of challenge texts for locating vulnerabilities and weaknesses in a target Generative AI system, the method comprising:
generating a plurality of rewritten texts from an original text, wherein generating each rewritten text comprises using an AI text generator configured for natural language processing and generation to apply a statistically unique sequence of operations to the original text;
determining semantic similarity of each rewritten text with the original text; and
adding to the set of challenge texts each rewritten text that has been determined to be semantically similar to the original text.

17. The computer program product of claim 16, wherein a distance function is used to determine the semantic similarity of each rewritten text.

18. The computer program product of claim 16, wherein the operations are applicable in randomly-generated amounts aiming to make each sequence unique from a statistical standpoint.

19. The computer program product of claim 18, wherein the method further comprises:
normalizing the randomly-generated amounts for each sequence, and
scaling the normalized amounts with a complexity level.

20. The computer program product of claim 16, wherein the operations comprise:
user-defined operations from a user interface;
pre-defined operations from storage; and
application-specific operations that are generated.
